(19) United States
(12) Patent Application Publication
(10) Pub. No.: US 2022/0348842 A1
(43) Pub. Date: Nov. 3, 2022

(54) Concentrated Flowable Washing Agent Preparation Having Improved Properties

(71) Applicant: Henkel AG & Co. KGaA, Duesseldorf (DE)

(72) Inventors: Inga Kerstin Vockenroth, Duesseldorf (DE); Barbara Busch, Neuss (DE)

(21) Appl. No.: 17/728,266

(22) Filed: Apr. 25, 2022

(30) Foreign Application Priority Data
Apr. 23, 2021 (DE) 102021204084.5

(51) Int. Cl. C11D 1/22; C11D 17/06; C11D 3/386; C11D 17/00; C11D 11/00

(52) U.S. Cl. CPC C11D 1/22; C11D 17/06; C11D 3/38636; C11D 17/0039; C11D 11/0017

(57) ABSTRACT

The invention relates to a flowable washing agent preparation containing, based on the total weight thereof, a) 2 to 20 wt. % anionic surfactant from the group of C₈₋₁₈ alkylbenzene sulfonates; b) 0.05 to 2 wt. % of a preparation of a pectinolytic enzyme; c) less than 20 wt. % water, to washing agent portion units containing these washing agent preparations and to washing methods using these washing agent preparations or washing agent portion units.

### FIELD OF THE INVENTION

The present invention relates to a surfactant- and enzyme-based washing agent preparation. The application also relates to washing agent portion units which comprise this washing agent preparation and to a method for washing textiles using the washing agent preparation or the washing agent portion unit.

### BACKGROUND OF THE INVENTION

Continuously changing requirements are placed on the forms in which washing and cleaning agents are manufactured and sold. For some time, the consumer has paid special attention to the easy dosing of washing and cleaning agents and the simplification of the operational steps required to carry out a washing or cleaning process. A technical solution is provided by pre-portioned washing or cleaning agents, for example film pouches having one or more receiving chambers for solid or liquid washing or cleaning agents.

A relevant trend for the production of these film pouches is the miniaturization of these film pouches. In addition to higher consumer acceptance due to simplified handling, the reason behind this development is in particular sustainability aspects, for example with regard to transport volumes and transport costs and the amount of packaging means used.

The concentration of modern washing agents, in particular modern liquid washing agents, generally influences the optical and rheological properties thereof, affects the storage stability of these agents, and can influence the cleaning performance thereof, in particular if the high concentration of the active ingredients leads to incompatibilities.

European patent EP 2 254 979 B1 describes solid textile washing agents with a small proportion of linear alkylbenzene sulfonic acid, which can also contain pectinases in addition to other enzymes.

International patent application WO 2015/121133A1 describes liquid textile washing agents with a high water content, which also contain pectinase in addition to small amounts of linear alkylbenzene sulfonic acid.

### BRIEF SUMMARY OF THE INVENTION

The problem addressed by the application was that of providing visually appealing, concentrated flowable washing agent preparations which can be produced in a simple and efficient manner, have a good shelf life and are characterized in particular by good cleaning results. In particular, the washing agent preparation should be able to be packaged in water- soluble sachets and should be based predominantly on ingredients which can be produced at least in part from renewable raw materials.

The application firstly relates to a flowable washing agent preparation containing, based on the total weight thereof,
a) 2 to 20 wt. % anionic surfactant from the group of C₈₋₁₈ alkylbenzene sulfonates;
b) 0.05 to 2 wt. % of a preparation of a pectinolytic enzyme;
c) less than 20 wt. % water.

The washing agent preparation is flowable under standard conditions (20° C., 1013 mbar).

### DETAILED DESCRIPTION OF THE INVENTION

A first essential component of the washing agent preparation is the C₈₋₁₈ alkylbenzene sulfonate, which is contained in the washing agent preparation in proportions by weight of 5 to 20 wt. %. Preferred washing agent preparations contain, based on the total weight thereof, 7 to 17 wt. %, preferably 9 to 15 wt. %, C₈₋₁₈ alkylbenzene sulfonate.

Preferred C₈₋₁₈ alkylbenzene sulphonates have the general formula (I),

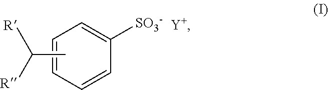

where
R′ and R″ are, independently of one another, H or alkyl, and together contain 8 to 18, preferably 9 to 15 and in particular 9 to 13, C atoms, and Y⁺ denotes a monovalent cation or the n-th part of an n-valent cation (in particular Na⁺).

In addition to the C₈₋₁₈ alkylbenzene sulfonates described above, the washing agent preparation can contain further anionic surfactants. The group of these further surfactants includes, for example, the alkyl ether sulfates, olefin sulfonates, C₁₂-C₁₈ alkane sulfonates, ester sulfonates, alk(en)yl sulfates and mixtures thereof. Nevertheless, it has been found that the washing agent preparation according to the invention achieves good washing results even without using these additional anionic surfactants. For reasons of reducing complexity, the greatest possible miniaturization of the required washing agent portion unit and an improved sustainability profile, it is therefore preferred if the washing agent preparation contains, based on the total weight thereof, less than 10 wt. %, preferably less than 6 wt. %, and in particular less than 2 wt. %, anionic surfactant from the group of alkyl ether sulfates. In addition, it can be advantageous if the washing agent preparation contains, based on the total weight thereof, in addition to the anionic surfactant from the group of C₈₋₁₈ alkylbenzene sulfonates, less than 10 wt. %, preferably less than 6 wt. % and in particular less than 2 wt. %, further anionic surfactant.

The use of fatty acids has proven to be advantageous for stability and cleaning performance. Preferred washing agent preparations therefore contain, based on the total weight thereof, 4 to 12 wt. %, preferably 6 to 10 wt. %, fatty acid. Particularly preferred fatty acids are selected from the group of caprylic acid, capric acid, lauric acid, myristic acid, palmitic acid, stearic acid, oleic acid, linoleic acid and mixtures thereof. In the context of the application, the fatty acids are not assigned to the group of anionic surfactants.

The use of non-ionic surfactants is advantageous for the cleaning performance of the washing agent preparations. The proportion by weight of the non-ionic surfactants with respect to the total weight of the washing agent preparation is preferably 15 to 34 wt. %, preferably 18 to 30 wt. %.

Preferred non-ionic surfactants are selected from the group of ethoxylated primary C₈₋₁₈ alcohols, preferably the ethoxylated primary C₈₋₁₈ alcohols having a degree of alkoxylation of ³ 4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

With regard to the rheological properties of the washing agent preparation and the processability and cleaning action thereof, it has proven advantageous to use non-ionic surfactant and anionic surfactant of from 2:1 to 3:2.

The washing agent preparation contains 0.05 to 2 wt. % of a preparation of a pectinolytic enzyme as a second essential component. In preferred embodiments, the proportion by weight of this preparation with respect to the total weight of the washing agent preparation is 0.1 to 0.4 wt. %.

In the context of the present invention, the pectinolytic enzymes include enzymes having the names pectinase, pectate lyase, pectin esterase, pectin demethoxylase, pectin methoxylase, pectin methylesterase, pectase, pectin methylesterase, pectinesterase, pectin pectyl hydrolase, pectin depolymerase, endopolygalacturonase, pectolase, pectin hydrolase, pectin polygalacturonase, 20 endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase, or 25 exopolygalacturanosidase. The use of pectin lyases is very particularly preferred here.

Within the EC classification of enzymes, the numerical classification system for enzymes, the pectinolytic enzymes belong in particular to the enzyme classes (“Enzyme Commission number”) EC 3.1.1.11, EC 3.2.1.15, EC 3.2.1.67 and EC 3.2.1.82 and consequently belong to the third of the six main enzyme classes, the 10 hydrolases (EC 3. hereunder to the glycosylases (EC 3.2.-.-) and again hereunder to the glycosidases (EC 3.2.1.-), i.e., enzymes that hydrolyze O- and/or S-glycosyl compounds. Consequently, pectinolytic enzymes act in particular against residues on dishes which contain pectic acid and/or other galacturonans, and catalyze the hydrolysis thereof.

In the context of the invention, pectate lyases are enzymes which catalyze the non-hydrolytic cleavage of pectate according to an endo mechanism.

Examples of suitable pectinolytic enzymes are the enzymes and enzyme preparations available under the trade names Gamanase®, Pektinex AR®, ^{XPect}® or Pectaway® from Novozymes, under the trade names Rohapect UF®, Rohapect TPL®, Rohapect PTE100®, Rohapect MPE®, 30 Rohapect MA plus HC, Rohapect DA12L®, Rohapect 10L®, Rohapect B1L® from AB Enzymes, and under the trade name Pyrolase® from Diversa Corp., San Diego, Calif., USA.

In addition to the actual enzyme protein, an enzyme preparation comprises further components such as enzyme stabilizers, carrier materials or fillers. The enzyme protein usually only forms a fraction of the total weight of the enzyme preparation. Enzyme preparations that are preferably used contain between 0.1 and 40 wt. %, preferably between 0.2 and 30 wt. %, more preferably between 0.4 and 20 wt. %, and most preferably between 0.8 and 10 wt. %, of the enzyme protein. In such compositions, an enzyme stabilizer can be contained in the enzyme composition in an amount of from 0.05 to 35 wt. %, preferably from 0.05 to 10 wt. %, based on the total weight.

The protein concentration can be determined using known methods, for example the BCA method (bicinchoninic acid; 2,2′-bichinolyl-4,4′-dicarboxylic acid) or the Biuret method. The active protein concentration is determined by titrating the active centers using a suitable irreversible inhibitor (for example, phenylmethylsulfonylfluoride (PMSF) for proteases) and determining the residual activity.

Preferred preparations of pectinolytic enzymes, in particular pectate lyase preparations, contain, based on the total weight thereof, a proportion by weight of active protein of 0.1 and 40 wt. %, preferably 0.2 and 30 wt. %.

In combination with the preparations of pectinolytic enzymes described above, in particular in combination with pectate lyase preparations, further enzyme preparations are used with particular preference in the washing agent preparation. The proportion by weight of these further enzyme preparations with respect to the total weight of the washing agent preparation is preferably 2 to 8 wt. % and in particular 3 to 6 wt. %.

It is preferred if the washing agent preparation according to the invention also contains, in addition to the preparation of pectinolytic enzyme, in particular in addition to the pectylase preparation, at least one enzyme preparation, preferably at least 3 enzyme preparations of enzymes from the group of amylase, mannanase, protease, cellulase and lipase.

It is preferred according to the invention if at least one protease is contained as the enzyme. A protease is an enzyme that cleaves peptide bonds by hydrolysis. According to the invention, each of the enzymes from class EC 3.4 is included (including each of the thirteen subclasses which fall thereunder). According to the invention, “protease activity” is present if the enzyme has proteolytic activity (EC 3.4). Different types of protease activity are known: The three main types are: trypsin-like, where the amide substrate is cleaved following the amino acids Arg or Lys at P1; chymotrypsin-like, where cleavage takes place following one of the hydrophobic amino acids at P1; and elastase-like, where the amide substrate is cleaved following Ala at P1.

Surprisingly, it was found that a protease of the type of alkaline protease from Bacillus lentus DSM 5483 or a protease sufficiently similar to this (based on the sequence identity) which has a plurality of these changes in combination is particularly suitable for use in the liquid washing agent preparation according to the invention and advantageously stabilized in an improved manner therein. Advantages of using this protease thus arise in particular with regard to washing performance and/or stability.

Very particularly preferably, the washing agent preparation according to the invention protease of the alkaline protease type from Bacillus lentus DSM 5483 or a protease which is sufficiently similar to this (based on the sequence identity) and has a plurality of these modifications in combination.

The proportion by weight of the protease preparation with respect to the total weight of the washing agent preparation is preferably 0.5 to 5 wt. % in particular 1.0 to 4 wt. %.

As a further preferred optional ingredient, the washing agent preparations contain a cellulase preparation. Synonymous terms can be used for cellulases, in particular endoglucanase, endo-1,4-beta-glucanase, carboxymethyl cellulase, endo-1,4-beta-D-glucanase, beta-1,4-glucanase, beta-1,4-endoglucanhydrolase, celludextrinase or avicelase. Within the meaning of the invention, whether or not an enzyme is a cellulase is decided by its ability to hydrolyze 1,4-B-D-glucosidic bonds in cellulose.

Cellulases (endoglucanases, EG) suitable according to the invention include, for example, fungal compositions rich in endoglucanase (EG), which are provided by the company Novozymes under the trade name Celluzyme®. The products Endolase® and Carezyme®, also available from Novozymes, are based on 50 kD-EG and 43 kD-EG, respectively, from Humicola insolens DSM 1800. Further commercial products from this company that can be used are Cellusoft®, Renozyme®, and Celluclean®. It is also possible to use cellulases, for example, which are available from AB Enzymes, Finland, under the trade names Ecostone® and Biotouch®, and which are, at least in part, based on 20 kD-EG from Melanocarpus. Further cellulases from AB Enzymes are Econase® and Ecopulp®. Other suitable cellulases are from Bacillus sp. CBS 670.93 and CBS 669.93, the cellulase from Bacillus sp. CBS 670.93 being available from Danisco/Genencor under the trade name Puradax®. Other commercial products from Danisco/Genencor that can be used are “Genencor detergent cellulase L” and IndiAge®Neutra.

The proportion by weight of the cellulase preparation with respect to the total weight of the washing agent preparation is preferably 0.05 to 1 wt. %, in particular 0.1 to 0.5 wt. %.

According to the invention, it is furthermore preferred if the washing agent preparation according to the invention contains at least one lipase preparation. Preferred lipases according to the invention are selected from at least one enzyme of the group which is formed from triacylglycerol lipase (EC 3.1.1.3), lipoprotein lipase (EC 3.1.1.34) and monoglyceride lipase (EC 3.1.1.23).

Preferred lipase preparations according to the invention are the commercial products marketed by Amano Pharmaceuticals under the names Lipase M-AP10®, Lipase LE® and Lipase F® (also Lipase JV®). For example, Lipase F® is naturally present in Rhizopus oryzae. Lipase M-AP10®, for example, is naturally present in Mucor javanicus.

A highly preferred lipase is commercially available from Novozymes (Denmark) under the trade name Lipex® and can advantageously be used in the washing agent preparations according to the invention. The Lipase Lipex® 100 L is particularly preferred here.

Preferred washing agent preparations are characterized in that they contain, based on the total weight thereof, 0.01 to 1 wt. %, in particular 0.02 to 0.4 wt. %, lipase preparation.

The washing agent preparations according to the invention can additionally contain at least one mannanase preparation as an enzyme. A mannanase catalyzes the hydrolysis of 1,4-beta-D-mannosidic bonds in mannans, galactomannans, glucomannans and galactoglucomannans. Said mannanases according to the invention are classified according to the enzyme nomenclature as EC 3.2.1.78.

Suitable mannanases are available from Novozymes under the trade name Mannaway®.

The proportion by weight of the mannanase preparation with respect to the total weight of the washing agent preparation is preferably 0.01 to 0.5 wt. %, in particular 0.02 to 0.2 wt. %.

The washing agent preparations preferably contain at least one amylase, in particular an α-amylase. α-amylases (EC 3.2.1.1) hydrolyze internal α-1,4-glycosidic bonds of starch and starch-like polymers as enzymes. As an example, α-amylases from Bacillus licheniformis, from B. amyloliquefaciens and from B. stearothermophilus, as well as the refinements thereof that have been improved for use in washing or cleaning agents, may be mentioned. The enzyme from B. licheniformis is available from Novozymes under the trade name Termamyl® and from Genencor under the trade name Purastar®ST. Development products of these a-amylases are available from Novozymes under the trade names Duramyl® and Termamyrultra, from Genencor under the name Purastar® OxAm, and from Daiwa Seiko Inc., Tokyo, Japan, as Keistase®. The a-amylase from B. amyloliquefaciens is marketed by Novozymes under the name BAN®, and derived variants from the α-amylase from B. stearothermophilus are marketed under the names BSG® and Novamyl®, also by Novozymes. Examples of α-amylases from other organisms are the refinements of α-amylase from Aspergillus niger and A. oryzae that are available under the trade name Fungamyl from Novozymes.

The proportion by weight of the amylase preparation, in particular the a-amylase preparation, with respect to the total weight of the washing agent preparation is preferably 0.1 to 2 wt. % in particular 0.2 to 1 wt. %.

Particularly preferred washing agent preparations also contain, in addition to the preparation of pectinolytic enzyme, in particular in addition to the pectylase preparation, at least one amylase preparation and at least one mannanase preparation and at least one protease preparation and at least one cellulase preparation and at least one lipase preparation.

The flowable washing agent preparations contain less than 20 wt. % water. In view of the desired miniaturization of the washing agent portion unit combined with high washing performance, it is preferable to further reduce this proportion by weight of water. Preference is therefore given to washing agent preparations which contain, based on the total weight thereof, less than 15 wt. % water, preferably 2 to 15 wt. % and in particular 2 to 12 wt. % water.

Due to the entry of water through the raw materials used, it is generally not possible to achieve complete freedom from water in the washing agent preparation. In addition to the water, the washing agent preparations preferably contain organic solvent. The use of aqueous-organic solvent systems has proven to be particularly advantageous for producibility and shelf life and is therefore particularly preferred.

In a preferred embodiment, the washing agent preparation contains, based on the total weight thereof, 15 to 42 wt. %, preferably 20 to 40 wt. % and in particular 25 to 38 wt. % organic solvent.

Preferred organic solvents are selected from the group of ethanol, n-propanol, propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3 -methyl-3 -methoxybutanol, propylene-glycol-t-butyl ether, di-n-octyl ether and mixtures thereof, preferably from the group of propanediol, glycerol, ethanol, and mixtures thereof.

In addition to the components described above, the washing agent preparations can contain other optional ingredients. A first group of preferred optional ingredients are the phosphonates.

The proportion by weight of the phosphonate with respect to the total weight of the washing agent preparation is preferably 0.1 to 3 wt. % and in particular 0.2 to 1 wt. %.

A hydroxy alkane phosphonate and/or amino alkane phosphonate is preferably used as a phosphonate compound. Among the hydroxyalkane phosphonates, 1-hydroxyethane-1,1-diphosphonate (HEDP) is of particular importance. Ethylenediamine tetramethylene phosphonate (EDTMP), diethylenetriamine pentamethylene phosphonate (DTPMP) and higher homologs thereof are preferably considered as aminoalkane phosphonates. The use of ethylene diamine tetramethylene phosphonate (EDTMP) and diethylene triamine pentamethylene phosphonate (DTPMP) is very particularly preferably selected.

As a further optional component, a preferred washing agent preparation comprises 0.2 to 4 wt. %, preferably 0.5 to 3 wt. %, fragrance preparation.

In addition to the actual fragrances, the fragrance preparation includes, for example, solvents, solid carrier materials or stabilizers.

A fragrance is a chemical substance that stimulates the sense of smell. In order to be able to stimulate the sense of smell, it should be possible to at least partially distribute the chemical substance in the air, i.e., the fragrance should be volatile at 25° C. at least to a small extent. If the fragrance is very volatile, the odor intensity abates quickly. At a lower volatility, however, the smell is longer-lasting, i.e., it does not disappear as quickly. In one embodiment, the fragrance therefore has a melting point in the range of from −100 ° C. to 100° C., preferably from −80° C. to 80 ° C., more preferably from −20° C. to 50° C., in particular from −30° C. to 20° C. In another embodiment, the fragrance has a boiling point in the range of from 25° C. to 400° C., preferably from 50° C. to 380° C., more preferably from 75° C. to 350° C., in particular from 100° C. to 330° C.

Overall, in order to act as a fragrance, a chemical substance should not exceed a certain molecular mass since, if the molecular mass is too high, the required volatility can no longer be ensured. In one embodiment, the fragrance has a molecular mass of from 40 to 700 g/mol, more preferably from 60 to 400 g/mol.

The odor of a fragrance is perceived by most people as pleasant and often corresponds to the smell of, for example, flowers, fruits, spices, bark, resin, leaves, grasses, mosses and roots. Fragrances can thus also be used to overlay unpleasant odors or even to provide a non-smelling substance with a desired odor. It is possible, for example, to use individual odorant compounds, such as synthetic products of the ester, ether, aldehyde, ketone, alcohol and hydrocarbon types, as fragrances.

Preferably, mixtures of different fragrances are used, which together produce an appealing fragrance note. Such a mixture of fragrances may also be referred to as perfume or perfume oil. Perfume oils of this kind may also contain natural fragrance mixtures, such as those obtainable from plant sources.

For the prolongation of the fragrance effect, it has proven to be advantageous to encapsulate the fragrance. In a corresponding embodiment, at least some of the fragrance is used in encapsulated form (fragrance capsules), in particular in microcapsules. However, it is also possible to use the entire fragrance in encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds that release the actual fragrance only after chemical conversion/cleavage, typically by exposure to light or other environmental conditions such as pH, temperature, etc. Such compounds are often also referred to as fragrance storage substances or “pro-fragrances.”

The composition of some preferred flowable washing agent preparations can be derived from the following tables (amounts given in wt. % based on the total weight of the preparation, unless otherwise indicated). The washing agent preparations are particularly preferably packaged as washing agent portion units in which the washing agent preparation is completely enclosed by a water-soluble film.

| | Formula 1 | Formula 2 | Formula 3 | Formula 4 |
|---|---|---|---|---|
| C₈₋₁₈ alkylbenzene sulfonate | 2 to 20 | 7 to 17 | 7 to 17 | 9 to 15 |
| Preparation of a pectinolytic enzyme, in | 0.05 to 2 | 0.05 to 1 | 0.1 to 0.6 | 0.1 to 0.4 |
| particular pectate lyase preparation | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 6 | Formula 7 | Formula 8 | Formula 9 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Preparation of a pectinolytic enzyme, in | 0.05 to 2 | 0.05 to 1 | 0.1 to 0.6 | 0.1 to 0.4 |
| particular pectate lyase preparation | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 11 | Formula 12 | Formula 13 | Formula 14 |
|---|---|---|---|---|
| C₈₋₁₈ alkylbenzene sulfonate | 2 to 20 | 7 to 17 | 7 to 17 | 9 to 15 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 16 | Formula 17 | Formula 18 | Formula 19 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 21 | Formula 22 | Formula 23 | Formula 24 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Fatty acid | 4 to 12 | 4 to 12 | 4 to 12 | 6 to 10 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 26 | Formula 27 | Formula 28 | Formula 29 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Preparation of a pectinolytic enzyme, | 0.05 to 2 | 0.05 to 1 | 0.1 to 0.6 | 0.1 to 0.4 |
| in particular pectate lyase preparation | | | | |
| Enzyme preparations containing | 2 to 8 | 2 to 8 | 2 to 8 | 3 to 6 |
| protease and amylase and cellulase and | | | | |
| mannanase and lipase | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 31 | Formula 32 | Formula 33 | Formula 34 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Enzyme preparations containing | 2 to 8 | 2 to 8 | 2 to 8 | 3 to 6 |
| protease and amylase and cellulase | | | | |
| and mannanase and lipase | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 36 | Formula 37 | Formula 38 | Formula 39 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Fatty acid | 4 to 12 | 4 to 12 | 4 to 12 | 6 to 10 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Enzyme preparations containing | 2 to 8 | 2 to 8 | 2 to 8 | 3 to 6 |
| protease and amylase and cellulase and | | | | |
| mannanase and lipase | | | | |
| Water | <20 | 2 to 15 | 2 to 15 | 2 to 12 |
| Misc. | to make up | to make up | to make up | to make up |
| | to 100 | to 100 | to 100 | to 100 |

| | Formula 41 | Formula 42 | Formula 43 | Formula 44 |
|---|---|---|---|---|
| C₈₋₁₈ alkylbenzene sulfonate | 2 to 20 | 7 to 17 | 7 to 17 | 9 to 15 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 46 | Formula 47 | Formula 48 | Formula 49 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 51 | Formula 52 | Formula 53 | Formula 54 |
|---|---|---|---|---|
| C₈₋₁₈ alkylbenzene sulfonate | 2 to 20 | 7 to 17 | 7 to 17 | 9 to 15 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 56 | Formula 57 | Formula 58 | Formula 59 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 61 | Formula 62 | Formula 63 | Formula 64 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Fatty acid | 4 to 12 | 4 to 12 | 4 to 12 | 6 to 10 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 66 | Formula 67 | Formula 68 | Formula 69 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Preparation of a pectinolytic enzyme, | 0.05 to 2 | 0.05 to 1 | 0.1 to 0.6 | 0.1 to 0.4 |
| in particular pectate lyase preparation | | | | |
| Enzyme preparations containing | 2 to 8 | 2 to 8 | 2 to 8 | 3 to 6 |
| protease and amylase and cellulase and | | | | |
| mannanase and lipase | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 71 | Formula 72 | Formula 73 | Formula 74 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Enzyme preparations containing | 2 to 8 | 2 to 8 | 2 to 8 | 3 to 6 |
| protease and amylase and cellulase and | | | | |
| mannanase and lipase | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

| | Formula 76 | Formula 77 | Formula 78 | Formula 79 |
|---|---|---|---|---|
| C₈₋₁₈ alkylbenzene sulfonate | 2 to 20 | 7 to 17 | 7 to 17 | 9 to 15 |
| Alkyl ether sulfate | <10 | <6 | <2 | <2 |
| Fatty acid | 4 to 12 | 4 to 12 | 4 to 12 | 6 to 10 |
| Non-ionic surfactant | 15 to 34 | 15 to 34 | 15 to 34 | 28 to 30 |
| Preparation of a pectinolytic enzyme, | 0.05 to 2 | 0.05 to 1 | 0.1 to 0.6 | 0.1 to 0.4 |
| in particular pectate lyase preparation | | | | |
| Enzyme preparations containing | 2 to 8 | 2 to 8 | 2 to 8 | 3 to 6 |
| protease and amylase and cellulase and | | | | |
| mannanase and lipase | | | | |
| Water | <20 | 2 to 15 | 2 to 15 | 2 to 12 |
| Organic solvent | 15 to 42 | 20 to 40 | 20 to 40 | 25 to 38 |
| Misc. | to make up | to make up | to make up | to make up |
| | to 100 | to 100 | to 100 | to 100 |

The substance systems described above are not only suitable for ensuring easy producibility, good shelf life and cleaning performance, but also allow a product appearance to be created that is attractive to the consumer. Washing agent preparations which are transparent and consequently have a low level of turbidity are identified as visually attractive. Preferred washing agent preparations therefore have a turbidity (HACH Turbidimeter 2100Q, 20° C., 10 ml cuvette) below 100 NTU, preferably below 50 NTU and in particular below 20 NTU.

The Nephelometric Turbidity Unit (NTU) is frequently used as an indication of transparency. It is a unit, used, for example, in water treatment, for measuring turbidity, for example in liquids. It is a unit of turbidity measured using a calibrated nephelometer. High NTU values are measured for clouded compositions, whereas low values are determined for clear compositions.

The HACH Turbidimeter 2100Q from Hach Company, Loveland, Colo. (USA) is used with the calibration substances StabICal Solution HACH (20 NTU), StabICal Solution HACH (100 NTU) and StabICal Solution HACH (800 NTU), all of which can also be produced by Hach Company. The measurement is filled with the composition to be analyzed in a 10 ml measuring cuvette having a cap and is carried out at 20° C.

At an NTU value (at 20° C.) of 60 or more, shaped bodies have a perceptible turbidity within the meaning of the invention, as can be seen with the naked eye.

The optical advantages of the concentrated washing agent preparations are particularly evident in packaging means, which in turn are transparent and allow a direct view of the washing agent composition. In addition to transparent plastics bottles, transparent pouches, in particular transparent water-soluble pouches, are therefore particularly preferred for packaging.

This application therefore further relates to a washing agent portion unit comprising
i) a washing agent preparation according to the invention
ii) a water-soluble film which completely encloses the washing agent preparation.

The water-soluble film in which the washing agent preparation is packaged can comprise one or more structurally different water-soluble polymer(s). Particularly suitable water-soluble polymer(s) include polymers from the group of (optionally acetalized) polyvinyl alcohols (PVAL) and the copolymers thereof.

Water-soluble films are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹, and in particular from 40,000 to 80,000 gmol⁻¹.

The production of polyvinyl alcohol and polyvinyl alcohol copolymers generally includes the hydrolysis of intermediate polyvinyl acetate. Preferred polyvinyl alcohols and polyvinyl alcohols have a degree of hydrolysis of 70 to 100 mol. %, preferably 80 to 90 mol. %, particularly preferably 81 to 89 mol. %, and in particular 82 to 88 mol. %.

Polyvinyl alcohol copolymers which include, in addition to vinyl alcohol, an ethylenically unsaturated carboxylic acid, or the salt or ester thereof, are preferred. Polyvinyl alcohol copolymers of this kind particularly preferably contain, in addition to vinyl alcohol, sulfonic acids such as 2-acrylamido-2-methyl-1-propane sulfonic acid (AMPS), acrylic acid, methacrylic acid, acrylic acid ester, methacrylic acid ester or mixtures thereof; of the esters, C₁₋₄ alkyl esters or C₁₋₄ hydroxyalkyl esters are preferred. Other suitable monomers are ethylenically unsaturated dicarboxylic acids, for example itaconic acid, maleic acid, fumaric acid and mixtures thereof.

Suitable water-soluble films for use are sold, inter alia, by MonoSol LLC, for example under the names M8630, M8720, M8310, C8400 or M8900. Films having the names Solublon® PT, Solublon® GA, Solublon® KC or Solublon® KL from Aicello Chemical Europe GmbH, or the VF-HP films from Kuraray, are also suitable, for example.

The water-soluble films can contain additional active ingredients or fillers, but also plasticizers and/or solvents, in particular water, as further ingredients.

The group of further active ingredients includes, for example, materials which protect the ingredients of the preparation enclosed by the film material from decomposition or deactivation by light irradiation. Antioxidants, UV absorbers and fluorescent dyes have proven to be particularly suitable for this.

Glycerol, ethylene glycol, diethylene glycol, propanediol, 2-methyl-1,3-propanediol, sorbitol or mixtures thereof, for example, can be used as plasticizers.

In order to reduce its coefficient of friction, the surface of the water-soluble film of the washing agent portion unit can optionally be powder-coated with fine powder. Sodium aluminosilicate, silica, talc and amylose are examples of suitable powdering agents.

Preferred water-soluble films are suitable for processing in a thermoforming apparatus.

The volume of the washing agent portion unit is preferably from 12 to 22 ml, in particular from 12 to 18 ml.

The washing agent portion unit according to one of the preceding points, wherein the washing agent portion unit has one to four receiving chambers, preferably three or four receiving chambers.

The application also relates to a method for cleaning textiles, in which method an above-described washing agent preparation or washing agent portion unit is introduced into the washing liquor of a textile washing machine.

In preferred method variants, the washing agent preparation or the washing agent portion unit is dosed directly into the drum or into the dispensing drawer of the textile washing machine.

The machine textile washing process is preferably carried out at temperatures of from 20° C. to 60° C., preferably from 30° C. to 45° C.

This application provides the following subjects, inter alia:
1. A flowable washing agent preparation containing, based on the total weight thereof,
   a) 2 to 20 wt. % anionic surfactant from the group of C₈₋₁₈ alkylbenzene sulfonates;
   b) 0.05 to 2 wt. % of a preparation of a pectinolytic enzyme;
   c) less than 20 wt. % water.
2. The washing agent preparation according to point 1, wherein the washing agent preparation contains, based on the total weight thereof, 7 to 17 wt. %, preferably 9 to 15 wt. %, C₈₋₁₈ alkylbenzene sulfonate.
3. The washing agent preparation according to one of the preceding points, wherein the C₈₋₁₈ alkylbenzene sulfonate has the formula (I),

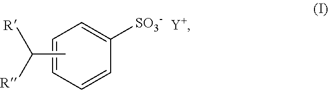

where R′ and R″ are, independently of one another, H or alkyl, and together contain 8 to 18, preferably 9 to 15 and in particular 9 to 13, C atoms, and Y⁺ denotes a monovalent cation or the n-th part of an n-valent cation, in particular Na⁺.
4. The washing agent preparation according to one of the preceding points, wherein the washing agent preparation contains, based on the total weight thereof, less than 10 wt. %, preferably less than 6 wt. %, and in particular less than 2 wt. %, anionic surfactant from the group of alkyl ether sulfates.
5. The washing agent preparation according to one of the preceding points, wherein the washing agent preparation contains, in addition to the anionic surfactant from the group of C₈₋₁₈ alkylbenzene sulfonates, based on the total weight thereof, less than 10 wt. %, preferably less than 6 wt. %, and in particular less than 2 wt. %, further anionic surfactant.
6. The washing agent preparation according to one of the preceding points, wherein the washing agent preparation contains, based on the total weight thereof, 4 to 12 wt. %, preferably 6 to 10 wt. %, fatty acid.
7. The washing agent preparation according to one of the preceding points wherein the washing agent preparation contains fatty acid selected from the group of caprylic acid, capric acid, lauric acid, myristic acid, palmitic acid, stearic acid, oleic acid, linoleic acid and mixtures thereof.
8. The washing agent preparation according to one of the preceding points, wherein the washing agent preparation contains, based on the total weight thereof, 15 to 34 wt. %, preferably 18 to 30 wt. %, non-ionic surfactant.
9. The washing agent preparation according to one of the preceding points, wherein the washing agent preparation contains non-ionic surfactant from the group of ethoxylated primary C₈₋₁₈ alcohols, preferably the ethoxylated primary C₈₋₁₈ alcohols having a degree of alkoxylation of³ 4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.
10. The washing agent preparation according to one of the preceding points, wherein the washing agent preparation contains non-ionic surfactant and anionic surfactant in a weight ratio of from 2:1 to 3:2.
11. The washing agent preparation according to one of the preceding points, wherein the washing agent preparation contains, based on the total weight thereof, 0.1 to 0.4 wt. % of a preparation of a pectinolytic enzyme.
12. The washing agent preparation according to one of the previous points, wherein the pectinolytic enzyme is selected from the group of pectate lyases.
13. The washing agent preparation according to one of the preceding points, wherein the washing agent preparation contains, based on the total weight thereof, 0.05 to 2 wt. %, preferably 0.1 to 0.4 wt. %, of a pectate lyase preparation.
14. The washing agent preparation according to one of the preceding points, wherein the preparation of a pectinolytic enzyme has, based on the total weight thereof, a proportion by weight of active protein of 0.1 to 40 wt. %, preferably 0.2 to 30 wt. %.
15. The washing agent preparation according to one of the preceding points, wherein the washing agent preparation further contains, in addition to the preparation of a pectinolytic enzyme, based on the total weight thereof, 2 to 8 wt. %, preferably 3 to 6 wt. %, enzyme preparation.
16. The washing agent preparation according to one of the preceding points, wherein the washing agent preparation also contains, in addition to the preparation of pectinolytic enzyme, at least one enzyme preparation, preferably at least 3 enzyme preparations of enzymes from the group of amylase, mannanase, protease, cellulase and lipase.
17. The washing agent preparation according to one of the preceding points, wherein the washing agent preparation also contains, in addition to the preparation of a pectinolytic enzyme, at least one amylase preparation and at least one mannanase preparation and at least one protease preparation and at least one cellulase preparation and at least one lipase preparation.
18. The washing agent preparation according to one of the preceding points, wherein the washing agent preparation contains, based on the total weight thereof, less than 15 wt. % water, preferably 2 to 15 wt. % and in particular 2 to 12 wt. % water.
19. The washing agent preparation according to one of the preceding points, wherein the washing agent preparation contains, based on the total weight thereof, 15 to 42 wt. %, preferably 20 to 40 wt. % and in particular 25 to 38 wt. %, organic solvent.
20. The flowable washing agent preparation according to one of the preceding points, wherein the washing agent preparation contains organic solvent selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl- 3-methoxybutanol, propylene-glycol-t-butylether, di-n-octylether and mixtures thereof, preferably from the group of propanediol, glycerol, ethanol and mixtures thereof.
   21. The washing agent preparation according to one of the preceding points, wherein the washing agent preparation contains, based on the total weight thereof, 0.1 to 3 wt. %, preferably 0.2 to 1 wt. %, phosphonate.
22. The washing agent preparation according to one of the preceding points, wherein the phosphonate is selected from the group of hydroxyalkane phosphonates and/or aminoalkane phosphonates, preferably from the group of aminoalkane phosphonates and in particular from the group of ethylenediamine tetramethylene phosphonate (EDTMP) and diethylenetriamine pentamethylene phosphonate (DTPMP).
23. The washing agent preparation according to one of the preceding points, wherein the washing agent preparation contains, based on the total weight thereof, 0.2 to 4 wt. %, preferably 0.5 to 3 wt. %, fragrance preparation.
24. The washing agent portion unit, comprising
   i) a washing agent preparation according to one of points 1 to 21
   ii) a water-soluble film which completely encloses the washing agent preparation.
25. The washing agent portion unit according to point 24, wherein the washing agent portion unit has a volume of from 12 to 22 ml, preferably from 12 to 18 ml.
26. The washing agent portion unit according to one of the preceding points, wherein the washing agent portion unit has one to four receiving chambers, preferably three or four receiving chambers.
27. A method for cleaning textiles, wherein a washing agent preparation according to one of points 1 to 23 or a washing agent portion unit according to one of points 24 to 26 is introduced into the washing liquor of a textile washing machine.

### EXAMPLES

Textile fabrics were provided with standardized soiling and then washed at 40° C. in washing liquors which contained 1 g/l of a washing agent V1 to V3 or E1. After washing, the textiles were dried. The brightness values of the cleaned textiles were determined. The values given were the averages from five washing tests.

TABLE 1
Washing agent composition (wt. %)

| | V1 | E2 | V2 |
|---|---|---|---|
| 1,2-propanediol | 6.0 | 6.0 | 6.0 |
| Glycerol | 24 | 24 | 12 |
| Ethanol | 3.2 | 3.2 | 3.2 |
| Water | 10.0 | 10.0 | 10.0 |
| Monoethanolamine | 4.0 | 4.0 | 6.0 |
| C₈₋₁₈ alkylbenzene sulfonate | — | 12 | 22 |
| Alkyl ether sulfate | 9 | — | — |
| Fatty acid | 9.0 | 9.0 | 9.0 |
| C12-18 fatty alcohol ethoxylate (7 EO) | 24 | 24 | 24 |
| DTPMP Na salt | 0.5 | 0.5 | 0.5 |
| Optical brightener | 0.5 | 0.5 | 0.5 |
| Perfume | 1.0 | 1.0 | 1.0 |
| Pectate lyase preparation | 0.3 | 0.3 | 0.3 |
| Other enzyme preparations | 3.5 | 3.5 | 3.5 |
| Misc. | to make up | to make up | to make up |
| | to 100 | to 100 | to 100 |

TABLE 2
Brightness value differences (Y values)

| Stain | Textile | V1 | E1 | V2 |
|---|---|---|---|---|
| Pectin with carbon black | Cotton | 44.7 | 52.1 | 48.1 |
| Pectin with carbon black | Cotton/polyester | 45.4 | 52.6 | 49.1 |

What is claimed is:

1. A flowable washing agent preparation containing, based on the total weight thereof,
a) 2 to 20 wt. % anionic surfactant from the group of C₈₋₁₈ alkylbenzene sulfonates;
b) 0.05 to 2 wt. % of a preparation of a pectinolytic enzyme;
c) less than 20 wt. % water.

2. The washing agent preparation according to claim 1, wherein the washing agent preparation contains, based on the total weight thereof, 7 to 17 wt. % C₈₋₁₈ alkylbenzene sulfonate.

3. The washing agent preparation according to claim 1, wherein the washing agent preparation contains, based on the total weight thereof, less than 10 wt. % anionic surfactant from the group of alkyl ether sulfates.

4. The washing agent preparation according to claim 1, wherein the washing agent preparation contains, in addition to the anionic surfactant from the group of C₈₋₁₈ alkylbenzene sulfonates, based on the total weight thereof, less than 10 wt. % further anionic surfactant.

5. The washing agent preparation according to claim 1, wherein the washing agent preparation contains, based on the total weight thereof, 0.1 to 0.4 wt. % of a preparation of a pectinolytic enzyme.

6. The washing agent preparation according to claim 1, wherein the pectinolytic enzyme is selected from the group of pectate lyases.

7. The washing agent preparation according to claim 1, wherein the washing agent preparation contains, based on the total weight thereof, less than 15 wt. % water.

8. A washing agent portion unit, comprising
i) a washing agent preparation according to claim 1,
ii) a water-soluble film which completely encloses the washing agent preparation.

9. The washing agent portion unit according to claim 8, wherein the washing agent portion unit has a volume from 12 to 22 ml.

10. A method for cleaning textiles, in which a washing agent preparation according to claim 1 is introduced into the washing liquor of a textile washing machine.

11. The washing agent preparation according to claim 2, wherein the washing agent preparation contains, based on the total weight thereof, 9 to 15 wt. % C₈₋₁₈ alkylbenzene sulfonate.

12. The washing agent preparation according to claim 3, wherein the washing agent preparation contains, based on the total weight thereof, less than 6 wt. % anionic surfactant from the group of alkyl ether sulfates.

13. The washing agent preparation according to claim 3, wherein the washing agent preparation contains, based on the total weight thereof, less than 2 wt. % anionic surfactant from the group of alkyl ether sulfates.

14. The washing agent preparation according to claim 4, wherein the washing agent preparation contains, in addition to the anionic surfactant from the group of C₈₋₁₈ alkylbenzene sulfonates, based on the total weight thereof, less than 6 wt. % further anionic surfactant.

15. The washing agent preparation according to claim 4, wherein the washing agent preparation contains, in addition to the anionic surfactant from the group of C₈₋₁₈ alkylbenzene sulfonates, based on the total weight thereof, less than 2 wt. % further anionic surfactant.

16. The washing agent preparation according to claim 7, wherein the washing agent preparation contains, based on the total weight thereof, 2 to 15 wt. % water.

17. The washing agent preparation according to claim 7, wherein the washing agent preparation contains, based on the total weight thereof, 2 to 12 wt. % water.

18. The washing agent portion unit according to claim 9, wherein the washing agent portion unit has a volume from 12 to 18 ml.

19. The washing agent portion unit according to claim 8 is introduced into the washing liquor of a textile washing machine.
